(19) United States
(12) Patent Application Publication
(10) Pub. No.: US 2009/0103126 A1
(43) Pub. Date: Apr. 23, 2009

(54) IMAGE FORMING APPARATUS WHICH SUPPORTS INTERNET PROTOCOL (IP) MANAGEMENT AND METHOD THEREOF

(75) Inventor: Jae-hyun PARK, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/193,980

(22) Filed: Aug. 19, 2008

(30) Foreign Application Priority Data
Oct. 18, 2007 (KR) 2007-104891

(51) Int. Cl. G06F 3/12

(52) U.S. Cl. 358/1.15

(57) ABSTRACT

An image forming apparatus including a network interface unit to connect to a terminal, and an IP management unit to control the network interface unit to set a new IP address to be a main IP address and set the current IP address to be a sub IP address, if the current IP address is changed by the terminal. A user may use the printing operation of the image forming apparatus conveniently even when the IP address of the image forming apparatus is changed.

### CROSS-REFERENCE TO RELATED APPLICATIONS

This application claims priority under 35 U.S.C. §119(a) from Korean Patent Application No. 2007-104891, filed Oct. 18, 2007, in the Korean Intellectual Property Office, the entire disclosure of which is hereby incorporated in its entirety by reference.

### BACKGROUND OF THE INVENTION

1. Field of the Invention

The present general inventive concept relates to an image forming apparatus which supports Internet Protocol (IP) address management, and a method thereof, and more particularly, an image forming apparatus which is connected to a network, has a plurality of IP addresses, and enables other users to adapt easily when the IP address of the image forming apparatus changes, and a method thereof.

2. Description of the Related Art

Developments in the fields of input and output devices have enabled an automated office. Image forming apparatuses such as laser beam printers, LED print head printers, copiers, or facsimiles are some of the examples of these input and output devices.

Printers, copiers, scanners, or facsimiles were generally used to be provided as independent machines, but today, the digital technology has enabled a variety of functions to be converged into a single device, and such device is often called a multi-function printer (MFP).

Conventionally, one image forming apparatus is connected with one user terminal in a local manner and used. However, the introduction of network technology such as local area network (LAN) has enabled one or more user terminals to be connected to an image forming apparatus and used.

FIG. 1 illustrates a printing method of a conventional image forming apparatus.

Referring to FIG. 1, user terminals 10a to 10n, a service providing server 20, and an image forming apparatus 30 are connected to each other by a single network (i.e., LAN).

The user terminals 10a to 10n receive service information and corresponding device information from the service providing server 20 and the image forming apparatus 30. The user terminals 10a to 10n may be implemented as the personal computers (PC).

The service providing server 20 possesses information about all the devices connected via the LAN, to provide corresponding service information upon request by the user terminals 10a to 10n. The corresponding service information may be Internet Protocols (IP) of the devices. Upon request by at least one of the user terminals 10a to 10n, or by the image forming apparatus 30, the service providing server 20 notifies a user with the service information using a pre-stored user list.

The image forming apparatus 30 provides its device information when requested by the user terminals 10a to 10n or by the service providing server 20 in the LAN, and prints out the received data according to the print command of the terminals 10a to 10n.

Meanwhile, a user may change the network IP of the image forming apparatus 30 using one 10a of the user terminals 10a to 10n. Or, in a dynamic host configuration protocol (DHCP) network environment, the IP addresses of the user terminal 10 and the image forming apparatus 30 may change in response to the switching on/off of the service providing server 20.

In the above cases, the user terminals 10b to 10n of the other users do not perceive the change of the IP address and thus transmit the print command and data to the previous IP address. Therefore, data transmission fails due to changed IP address and the printing job is not conducted. Furthermore, other users have difficulty obtaining the changed IP address.

### SUMMARY OF THE INVENTION

The present general inventive concept provides an image forming apparatus which has a plurality of Internet Protocol (IP) addresses, and which enables other users to adapt easily to the change of an IP address of the image forming apparatus when a user changes the IP address of the image forming apparatus, and a method of IP address management.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus having a plurality of Internet protocol (IP) addresses, where the apparatus includes a network interface unit to connect to at least one terminal via a communications network, and an IP management unit to control the network interface unit to set a new IP address to be a main IP address and set the current IP address to be a sub IP address, if the current IP address is changed.

One of the terminals may change the current IP address of the image forming apparatus.

The IP address may be changed by a static mode or dynamic host configuration protocol (DHCP) IP address allocation.

The image forming apparatus may further include a display unit to display the main and sub IP addresses.

The image forming apparatus may further include a control unit to notify at least one terminal that the current IP address has changed.

The image forming apparatus may further include a control unit to execute a print job, if the print job is received from the at least one terminal connected via the communications network through the main IP address or the sub IP address.

The control unit may notify the at least one terminal that the IP address has changed, if the print job is received from the at least one terminal connected via the communications network through the sub IP address.

The control unit may notify the at least one terminal via the communications network that the IP address is changed using a simple network management protocol (SNMP) trap packet.

The image forming apparatus may further include a control unit to send out an address resolution protocol (ARP) packet through the network interface unit to determine whether at least one of the terminals connected to the communications network are using the sub IP address, if the IP address is changed.

The control unit may control the IP management unit to avoid using the sub IP address, if another terminal is using the sub IP address.

The foregoing and/or other aspects and utilities of the present general inventive concept may also be achieved by providing a method of Internet protocol (IP) address management of an image forming apparatus having a plurality of IP addresses, the method including changing a current IP address of the image forming apparatus, and setting a new IP address to be a main IP address and setting the current IP address to be a sub IP address.

The change of the IP address may be performed by a static mode or dynamic host configuration protocol (DHCP) IP allocating method.

The method may further include displaying the main and sub IP addresses on the image forming apparatus.

The method may further include notifying the at least one user terminal connected to the image forming apparatus via a communications network of the main IP address.

The method may further include executing a print job, if the print job is received from a connected terminal through the main IP address or the sub IP address.

The method may further include notifying the terminal that the IP address has changed, if the print job is received from the connected terminal through the sub IP address.

The method may further including notifying the terminal that the IP address has changed using a simple network management protocol (SNMP) trap packet.

The method may further include sending out an address resolution protocol (ARP) packet through the network interface unit to determine whether one or more terminals connected to the image forming apparatus via a communications network are using the sub IP address, if the IP address is changed.

The method may further include setting the IP management unit to avoid using the sub IP address, if other terminals connected to the image forming apparatus via a communications network are using the sub IP address.

The foregoing and/or other aspects and utilities of the present general inventive concept may also be achieved by providing a computer readable medium having embodied thereon a computer program to execute a method of Internet protocol (IP) address management of an image forming apparatus having a plurality of IP addresses, the method including changing a current IP address of the image forming apparatus, and setting a new IP address to be a main IP address and setting the current IP address to be a sub IP address.

The foregoing and/or other aspects and utilities of the present general inventive concept may also be achieved by providing a method of Internet protocol (IP) address management of an image forming apparatus communicatively coupled to a communications network, the method including receiving a new IP address for the image forming apparatus, and setting the new IP address to be a main IP address and setting a pre-existing IP address of the image forming apparatus to be a sub IP address.

The method may include that the new IP address may be received from a terminal connected to the image forming apparatus via the communications network.

The method may include that the new IP address may be received from a service providing server connected to the image forming apparatus via the communications network.

The method may include notifying at least one terminal connected to the image forming apparatus via the communications network that the new IP address has been set as the main IP address.

The method may further include receiving a print request from at least one terminal connected to the image forming apparatus via a communications network, and executing the print request if the request is received via the main IP address or the sub IP address of the image forming apparatus.

The foregoing and/or other aspects and utilities of the present general inventive concept may also be achieved by providing a computer readable medium having embodied thereon a computer program to execute a method of Internet protocol (IP) address management of an image forming apparatus communicatively coupled to a communications network, the method including receiving a new IP address for the image forming apparatus, and setting the new IP address to be a main IP address and setting a pre-existing IP address of the image forming apparatus to be a sub IP address.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates a printing method of a conventional image forming apparatus;

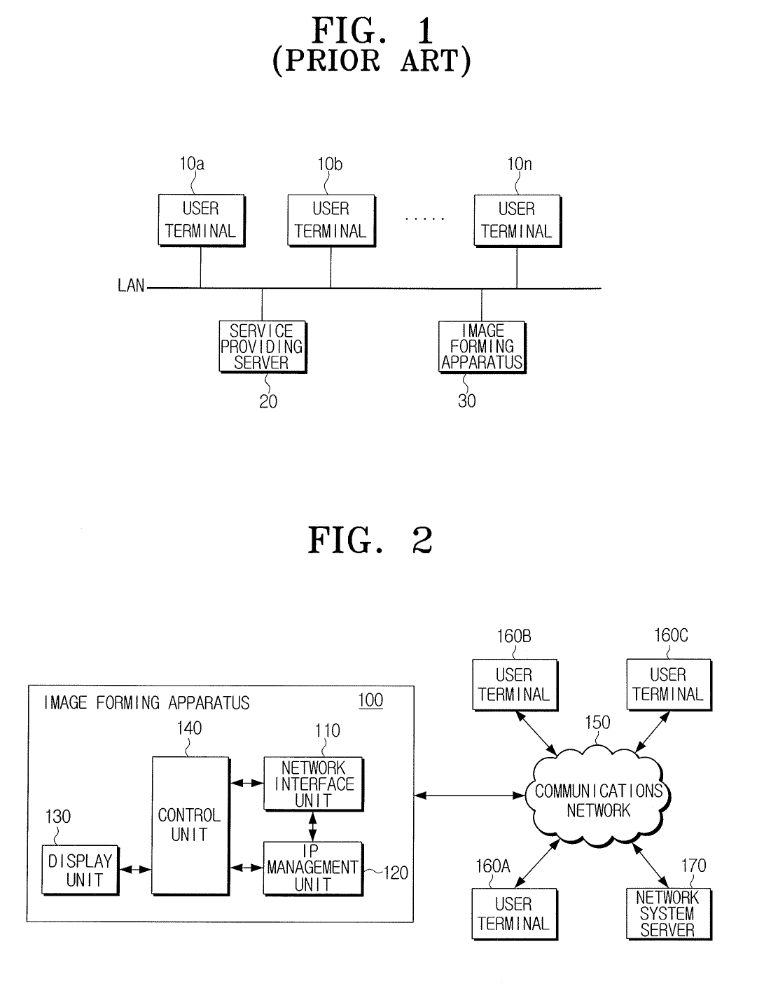

FIG. 2 illustrates a block diagram of an image forming apparatus according to an exemplary embodiment of the present general inventive concept; and

FIGS. 3 to 5 are flowcharts illustrating exemplary methods of IP address management according to a variety of embodiments of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

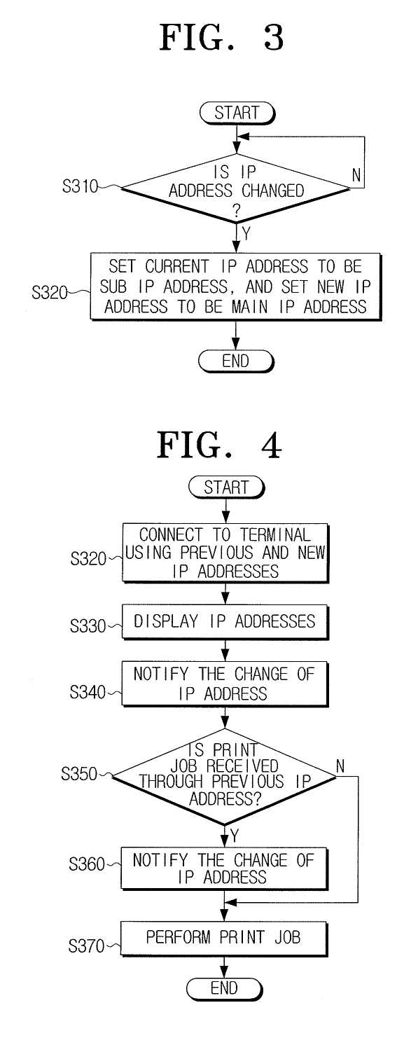

FIG. 2 is a block diagram illustrating an image forming apparatus according to an exemplary embodiment of the present general inventive concept.

Referring to FIG. 2, an image forming apparatus 100 according to an exemplary embodiment of the present general inventive concept includes a network interface unit 110, an IP management unit 120, a display unit 130, and a control unit 140.

The network interface unit 110 is connected to a terminal (e.g., the terminal 160A, 160B, or 160C, etc.) via a communications network 150. The network interface unit 110 receives print data and print control command from the terminal, and also operates to transmit corresponding information according to the control of the control unit 140 when the IP address of the image forming apparatus 100 is changed. The network interface unit 110 may be connected to a plurality of terminals (e.g., terminal 160A, 160B, or 160C, etc.) via a predetermined wired and/or wireless communications network, such as a LAN and/or the communications network 150. For example, the network interface unit 110 may be implemented as a network card that has a plurality of IP addresses, or alternatively, may be a plurality of network cards each having one IP addresses.

The IP management unit 120 controls the network interface unit 110 so that when the IP address is changed by the terminal, the network interface unit 110 uses the changed IP address along with at least one of the previous IP addresses. The static mode or dynamic host configuration protocol (DHCP) IP allocating method may be implemented according to the network environment of the image forming apparatus 100. If the static mode address allocation is implemented, a user changes the IP address of the image forming apparatus 100. If the DHCP address allocation is implemented, the IP address is changed not only by a user, but also by the switching on/off of the service providing server.

In the network environment, the image forming apparatus 100 can be allocated with a plurality of IP addresses, and the IP management unit 120 can set a new IP address in one of these IP addresses as the main address. The previous IP addresses may not be deleted, but set to be sub IP addresses and used together.

For example, the image forming apparatus 100 may be allocated with two IP addresses, and the IP address may be changed by the user or by a command of the network system server (e.g., a network system server 170). In this case, the previous IP address is set to be the second IP address, while the newly received IP address is set to be the first IP address. If the IP address is further changed by the terminal, the new IP address is set to be the first IP address, the previous first IP address is set to be the second IP address, and the previous second IP address is deleted. According to one implementation, the IP addresses may be stored to a NVRAM (non-volatile random access memory). According to another implementation, three or more IP addresses may be allocated to be the IP addresses of the image forming apparatus 100.

The display unit 130 displays the main IP address and the sub IP address. Specifically, the display unit 130 may display a user interface window on a screen of the image forming apparatus 100, and illustrates the current main IP address and sub IP address on a certain area of the user interface window.

The control unit 140 may notify at least one different user if the main IP address is changed. Conventionally, different users do not know the changed IP address. According to the present general inventive concept, in addition to notifying different users (e.g., the terminals 160A, 160B, 160C, etc.) that the IP address has changed, the changed main IP address is provided to the different users so that these users are encouraged to use the changed main IP address.

The changed IP address may be notified to the terminals connected to the wired and/or wireless communications network (e.g., the communications network 150) using broadcasting or multicasting. Alternatively, the control unit 140 may directly notify the users using electronic mail (e-mail) or short messaging service (SMS) through a predetermined mail server or SMS server connected to the network via a wireless or wired communications link (e.g., the communications network 150).

The control unit 140 receives a print job from a connected terminal to the main IP address or sub IP address, and executes the print job. The control unit 140 receives the print job to not only the changed IP address, but also the sub IP address, which is the previous IP address. As a result, the user may not know the changed IP address, but still is able to carry out a print job through the previous IP address.

The control unit 140 may notify a terminal that transmits a print job to the sub IP address that the IP address has changed. Specifically, a user who is sending a print job to the sub IP address may not notice the change of the IP address if a terminal is in an off state. Accordingly, the control unit 140 notifies the change of the IP address. Since it is necessary to notify only a user who does not know the change of the IP address, the changed IP address may be unicast. Specifically, the control unit 140 may notify the main IP address using a simple network management protocol (SMNP) trap.

If an IP address is changed, the control unit 140 may control the network interface unit 110 to send out an address resolution protocol (ARP) packet to determine whether the sub IP address is currently being used by other terminals. Specifically, an IP address of the image forming apparatus 100 may be changed, that is, newly allocated due to switching on/off of a service providing server (e.g., the network system server 170) in a network environment using a high-bandwidth digital content protection (HDCP) IP address allocation.

In such a network environment, the terminals as well as the image forming apparatus 100 are allocated with the new I P address, and so that the previous I P address of the image forming apparatus 100 may be allocated to the other terminal. Accordingly, the control unit 140 may send out an ARP packet to determine whether the other terminal or other image forming apparatus is using the sub IP address. If the sub IP address is allocated to the other terminal or the other image forming apparatus, an IP collision may occur. Accordingly, the control unit 140 may control the IP management unit 120 to avoid using the sub IP address.

The control unit 140 may cause an ARP packet to be sent only in a DHCP address allocation system. The control unit 140 may also control the IP management unit 120 to avoid using the sub IP address if the control unit 140 receives an ARP packet from the other terminals.

While the IP management unit 120 and the control unit 140 have been explained as the independent parts from each other, this should not be construed as limiting. For example, the control unit 140 may include the function of the IP management unit 120, or the IP management unit 120 may include the function of the control unit 140. In other words, either the IP management unit 120 or the control unit 140 may be implemented to control the management of a plurality of IP addresses.

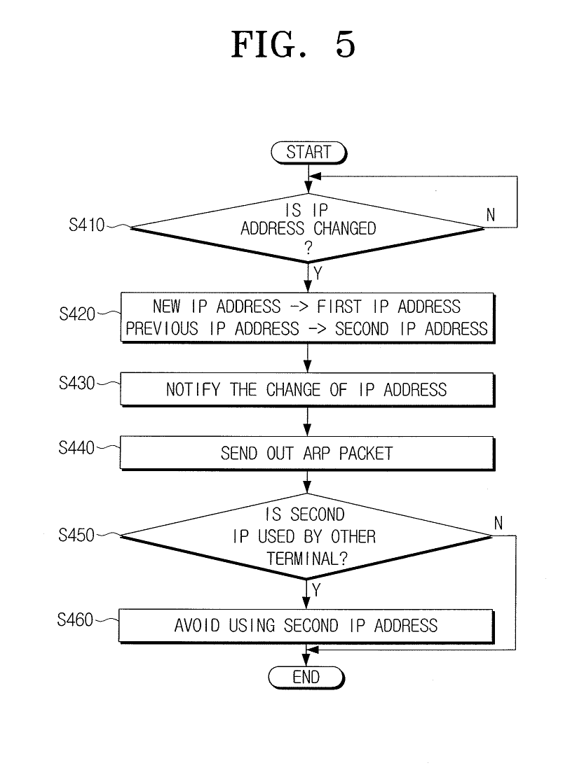

FIGS. 3 and 4 are flowcharts illustrating methods of IP address management according to exemplary embodiments of the present general inventive concept.

If, through the current IP address, a command to change an IP address is received from a terminal and a server during printing, the IP address is changed at operation S310.

In operation S320, the changed IP address and at least one previous IP address are set to be used together in an image forming apparatus. Specifically, the previous IP address is set to be a sub IP address, and the new IP address is set to be a main IP address. For example, if the image forming apparatus is set to be operated with two IP addresses, the previous IP address may be set to be a second IP address and the new IP address may be set to be a first IP address.

In operation S330, if an IP address is changed, the main and sub IP addresses are displayed on the image forming apparatus. Specifically, the main and sub IP addresses may be displayed on a predetermined area of a user interface. According to an exemplary embodiment, an IP address may be displayed on a specific area of the user interface, and may continue to be displayed after the notification of an IP address is receive, as explained in detail below.

In operation S340, a user (e.g., at a terminal) is notified of the new main IP address. A user may be notified that the IP address of the image forming apparatus has changed, and the new IP address of the image forming apparatus by broadcasting or multicasting using mailing or SMS through a network notice, mail server, or SMS server.

In operation S350, if a print job is received after the change of an IP address, a general print job is executed in operation s370 if the received IP address is a newly set IP address such as the first IP address. However, if the received print request is received through the previous IP address such as the second IP address, the change of the IP address is notified to a corresponding terminal in operation s360, and the print job is executed in operation S370. According to one implementation, the change of IP address may be notified after completion of the print job. Accordingly, while the user does not know the changed main IP address, he is still able to carry out a job through the sub IP address which is the previous IP address, and also know the new IP address with ease.

FIG. 5 is a flowchart to explain a method of IP address management according to another exemplary embodiment of the present general inventive concept.

In operation S410, if a command to change an IP address of a terminal and a server is received during printing using a current IP address, the current IP address is changed.

In operation S420, if the image forming apparatus is set to be operated with two IP addresses, the current IP address is set to be the second IP address and the newly received IP address is set to be the first IP address.

In operation S430, the user is notified of the new IP address. In operation S440, an ARP packet is transmitted to determine whether other terminals or other image forming apparatuses are using the second IP address, that is, the previous address. In operation S450, it is determined whether the other terminals or other image forming apparatuses are using the second IP address. In operation S460, the operations may proceed as explained above with reference to FIGS. 3 and 4 if the other terminals are not using the previous IP address, while the use of the second IP address is avoided if the previous IP address is currently used by the other terminals. According to another example, an ARP packet may be sent only when it is determined that a DHCP address allocation system is implemented. Alternatively, the use of the previous IP address may be avoided if an ARP packet is received from other terminal when there is no ARP packet sent out. Therefore, the users know the new I P address with ease in various network environments.

According to the exemplary embodiments of the present general inventive concept, the image forming apparatus has a plurality of IP addresses and users are able to continue printing even when they do not know that the current IP address is changed, or the new IP address. Furthermore, user convenience improves since the users are able to know the information about the change of the IP address with ease.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus having a plurality of Internet protocol (IP) addresses, the image forming apparatus comprising:
a network interface unit to connect to at least one terminal via a communications network; and
an IP management unit to control the network interface unit to set a new IP address to be a main IP address and set the current IP address to be a sub IP address, if the current IP address is changed.

2. The image forming apparatus of claim 1, wherein one of the at least one terminals changes the current IP address of the image forming apparatus.

3. The image forming apparatus of claim 1, wherein the IP address is changed by a static mode or dynamic host configuration protocol (DHCP) IP address allocation.

4. The image forming apparatus of claim 1, further comprising a display unit to display the main and sub IP addresses.

5. The image forming apparatus of claim 1, further comprising a control unit to notify at least one of the at least one terminals that the current IP address has changed.

6. The image forming apparatus of claim 1, further comprising a control unit to execute a print job, if the print job is received from the at least one terminal connected via the communications network through the main IP address or the sub IP address.

7. The image forming apparatus of claim 6, wherein the control unit notifies the at least one terminal that the IP address has changed, if the print job is received from the at least one terminal connected via the communications network through the sub IP address.

8. The image forming apparatus of claim 7, wherein the control unit notifies the at least one terminal via the communications network that the IP address has changed using a simple network management protocol (SNMP) trap packet.

9. The image forming apparatus of claim 1, further comprising a control unit to send out an address resolution protocol (ARP) packet through the network interface unit to determine whether at least one of the at least one terminals connected to the communications network is using the sub IP address, if the IP address is changed.

10. The image forming apparatus of claim 9, wherein the control unit controls the IP management unit to avoid using the sub IP address, if another terminal of the at least one terminals is using the sub IP address.

11. A method of Internet protocol (IP) address management of an image forming apparatus having a plurality of IP addresses, the method comprising:
changing a current IP address of the image forming apparatus; and
setting a new IP address to be a main IP address and setting the current IP address to be a sub IP address.

12. The method of claim 11, wherein the change of the IP address is performed by a static mode or dynamic host configuration protocol (DHCP) IP allocating method.

13. The method of claim 11, further comprising displaying the main and sub IP addresses on the image forming apparatus.

14. The method of claim 11, further comprising notifying at least one terminal connected to the image forming apparatus via a communications network of the main IP address.

15. The method of claim 11, further comprising executing a print job, if the print job is received from a connected terminal through the main IP address or the sub IP address.

16. The method of claim 11, further comprising:
if the print job is received through the sub IP address from a terminal connected to the image forming apparatus via a communications network, notifying the terminal that the IP address of the image forming apparatus has changed.

17. The method of claim 16, wherein the notifying the terminal that the IP address of the image forming apparatus has changed comprises using a simple network management protocol (SNMP) trap packet.

18. The method of claim 11, further comprising:
if the IP address of the image forming apparatus has changed, sending out an address resolution protocol (ARP) packet through the network interface unit to determine whether one or more terminals connected to the image forming apparatus via a communications network are using the sub IP address.

19. The method of claim 18, further comprising:
setting an IP management unit of the image forming apparatus to avoid using the sub IP address, if one or more terminals connected to the image forming apparatus via a communications network are using the sub IP address.

20. A method of Internet protocol (IP) address management of an image forming apparatus communicatively coupled to a communications network, the method comprising:
receiving a new IP address for the image forming apparatus; and
setting the new IP address to be a main IP address and setting a pre-existing IP address of the image forming apparatus to be a sub IP address.

21. The method of claim 20, wherein the new IP address is received from a terminal connected to the image forming apparatus via the communications network.

22. The method of claim 20, wherein the new IP address is received from a service providing server connected to the image forming apparatus via the communications network.

23. The method of claim 20, further comprising notifying at least one terminal connected to the image forming apparatus via the communications network that the new IP address has been set as the main IP address.

24. The method of claim 20, further comprising:
receiving a print request from at least one terminal connected to the image forming apparatus via a communications network; and
executing the print request if the request is received via the main IP address or the sub IP address of the image forming apparatus.
